(19) United States
(12) Patent Application Publication
(10) Pub. No.: US 2012/0008618 A1
(43) Pub. Date: Jan. 12, 2012

(54) METHODS AND APPARATUS FOR TIMING SYNCHRONIZATION USING MULTIPLE DIFFERENT TIMING SIGNAL SOURCES

(75) Inventors: Hua Wang, Bridgewater, NJ (US); Xinzhou Wu, Monmouth Junction, NJ (US); Junyi Li, Chester, NJ (US); Aleksandar Jovicic, Jersey City, NJ (US)

(73) Assignee: QUALCOMM Incorporated, San Diego, CA (US)

(21) Appl. No.: 12/832,758

(22) Filed: Jul. 8, 2010

(51) Int. Cl. H04J 3/06

(52) U.S. Cl. 370/350

(57) ABSTRACT

A wireless terminal detects timing signals from different local timing signal sources. The wireless terminal selects from the plurality of detected timing signal sources two timing signal sources in accordance with a predetermined timing signal source priority ordering. In some embodiments, the wireless terminal intentionally selects two timing signal sources which are not synchronized with respect to one another. The wireless terminal determines a first set of peer communications time intervals corresponding to a first selected timing signal source and a second set of peer communications time intervals corresponding to a second selected timing signal source. The wireless terminal transmits a peer to peer signal, e.g., a peer discovery signal, during at least one of the first set of peer communications time intervals. The wireless terminal transmits a peer to peer signal, e.g., a peer discovery signal, during at least one of the second set of peer communications time intervals.

### FIELD

Various embodiments relate to wireless communications, and more particularly, to methods and apparatus related to timing synchronization communications networks, e.g., peer to peer networks.

### BACKGROUND

In peer to peer networks, different groups of mobiles may synchronize to different local signals. As devices move and/or signal coverage areas overlap, signals from devices synchronized to different local timing synchronization signals may collide or go undetected making it difficult for peer devices to interact. Devices participating in one local peer to peer network synchronized to a first local signal may be unaware of devices in another adjacent or overlapping local peer to peer network synchronized to a different local signal.

One approach to coordinating multiple local peer to peer networks is to use a global timing synchronization source, e.g., GPS, and to timing synchronize each of the local networks based on the single global timing source. However, in many deployment scenarios, a global clock may not be available at each of the areas in which local peer to peer networks are to be operated and/or it may not be feasible to implement global synchronization. For example, consider that the global timing source is a GPS timing signal. At some locations, the GPS timing signal may be unavailable due to obstructions between the receiver and a GPS satellite. In addition, some devices, e.g., some mobile wireless terminals, may not include a GPS receiver in the design for cost, power, weight and/or complexity considerations.

In scenarios where a global timing signal source is not available or is not used to achieve synchronization in local peer to peer networks there is a need for methods and apparatus to allow for coordinated reception and transmission between devices in different local networks.

### SUMMARY

Various embodiments relate to timing synchronization and the exchange of signals, e.g., control and/or data signals. The methods and apparatus may be used in, e.g., a system where devices are locally synchronized and different time clocks are used at different geographical locations. Various described methods and apparatus support reliable signaling exchanges in deployments using local timing synchronization sources. Various described methods and apparatus are well suited for peer to peer communications systems in which a plurality of local peer to peer networks may be operating concurrently which are not timing synchronized with respect to one another. In some embodiments the signals which are exchanged include peer discovery signals.

A wireless terminal, e.g., a mobile node supporting peer to peer communications, monitors for and detects timing signals from different local timing signal sources. The wireless terminal selects from the plurality of detected timing signal sources two timing signal sources in accordance with a predetermined timing signal source priority ordering. In some embodiments, the wireless terminal intentionally selects two timing signal sources which are not synchronized with respect to one another. In some such embodiments, the wireless terminal achieves synchronization with respect to two or more different unsynchronized peer to peer recurring timing structures. The wireless terminal determines a first set of peer communications time intervals corresponding to a first selected timing signal source and a second set of peer communications time intervals corresponding to a second selected timing signal source. The wireless terminal transmits a peer to peer signal, e.g., a peer discovery signal, during at least one of the first set of peer communications time intervals. The wireless terminal transmits a peer to peer signal, e.g., a peer discovery signal, during at least one of the second set of peer communications time intervals. The wireless terminal also monitors for and receives peer to peer signals, e.g., peer discovery signals during at least some of the first set of peer communications time intervals and at least some of the second set of peer communications time intervals.

While described in the context of selecting and using two timing signal sources, in some embodiments more than two timing signal sources are selected and used with each selected timing signal source providing different timing, e.g., the selected timing signal sources are not synchronized. Each of the selected timing signals sources is used in one particular exemplary embodiment for transmitting and/or receiving signals in accordance with the timing determined from the particular selected one of the timing signal sources. In at least some embodiments where multiple different types of timing signal sources are available, N different timing signals sources are selected and used for timing purposes, e.g., discovery signal transmission and reception purposes. In some embodiments N is two. However, in other embodiments N is greater than two, e.g., three, four or five. The N selected timing signal sources in some embodiments differ in the type of signal source in addition to the timing provided. Different types of timing signal sources may include cellular base station signal sources, TV stations, Radio stations and/or other types of local timing signal sources. In some embodiments where there are more than N different types of timing signal sources available, each of the N timing signal sources is selected to be of a different type. When there are more than N different types of timing signal sources available to select from, the selection process may be made according to a predetermined prioritization of timing signal sources according to type. In other embodiments timing signal source coverage area is considered as an alternative to or in addition to timing signal source type when making the selection of which timing signal sources to use at a given time. In at least some such embodiments, timing signal sources with larger coverage areas are preferred over timing signal sources corresponding to small geographic coverage areas.

An exemplary method of operating a wireless terminal, in accordance with some embodiments, comprises: detecting timing signal sources which may be used for synchronizing peer to peer communications; and determining a first set of peer communications time intervals based on a first detected timing signal and a second set of peer communications time intervals based on a second detected timing signal, said first and second timing signals corresponding to different timing signal sources. The exemplary method further comprises: transmitting a first peer to peer signal during at least one of the first set of time intervals and transmitting a second peer to peer signal during at least one of the second set of time intervals.

An exemplary wireless terminal, in accordance with various embodiments, comprises: at least one processor configured to: detect timing signal sources which may be used for synchronizing peer to peer communications and determine a first set of peer communications time intervals based on a first detected timing signal and a second set of peer communications time intervals based on a second detected timing signal, said first and second timing signals corresponding to different timing signal sources. The at least one processor is further configured to: transmit a first peer to peer signal during at least one of the first set of time intervals and transmit a second peer to peer signal during at least one of the second set of time intervals. The exemplary wireless terminal further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary wireless communications system, e.g., a peer to peer wireless communications system, in accordance with an exemplary embodiment.

FIG. 2 is a flowchart illustrating exemplary methods of operating a wireless terminal, e.g., a mobile node, in accordance with various exemplary embodiments.

FIG. 3 is an exemplary wireless terminal in accordance with an exemplary embodiment.

FIG. 4 is an assembly of modules which may be used in the exemplary wireless terminal of FIG. 3.

FIG. 5 illustrates an exemplary timing signal source priority ordering table that may be used in the method of the flowchart of FIG. 2 and/or the wireless terminal of FIG. 3 in accordance with an exemplary embodiment.

FIG. 6 illustrates another exemplary timing signal source priority ordering table that may be used in the method of the flowchart of FIG. 2 and/or the wireless terminal of FIG. 3 in accordance with an exemplary embodiment.

FIG. 7 illustrates yet another exemplary timing signal source priority ordering table that may be used in the method of the flowchart of FIG. 2 and/or the wireless terminal of FIG. 3 in accordance with an exemplary embodiment.

FIG. 8 illustrates yet another exemplary timing signal source priority ordering table that may be used in the method of the flowchart of FIG. 2 and/or the wireless terminal of FIG. 3 in accordance with an exemplary embodiment.

FIG. 9 illustrates yet another exemplary timing signal source priority ordering table that may be used in the method of the flowchart of FIG. 2 and/or the wireless terminal of FIG. 3 in accordance with an exemplary embodiment.

FIG. 10 illustrates yet another exemplary timing signal source priority ordering table that may be used in the method of the flowchart of FIG. 2 and/or the wireless terminal of FIG. 3 in accordance with an exemplary embodiment.

FIG. 11 is a drawing illustrating exemplary timing signal source signals and corresponding sets of peer to peer time intervals.

FIG. 12 illustrates a first part of an example, in which a wireless terminal implements a method in accordance with the method of flowchart of FIG. 2 using timing signal source priority ordering table of FIG. 9.

FIG. 13 illustrates a second part of an example, in which a wireless terminal implements a method in accordance with the method of flowchart of FIG. 2 using timing signal source priority ordering table of FIG. 9.

### DETAILED DESCRIPTION

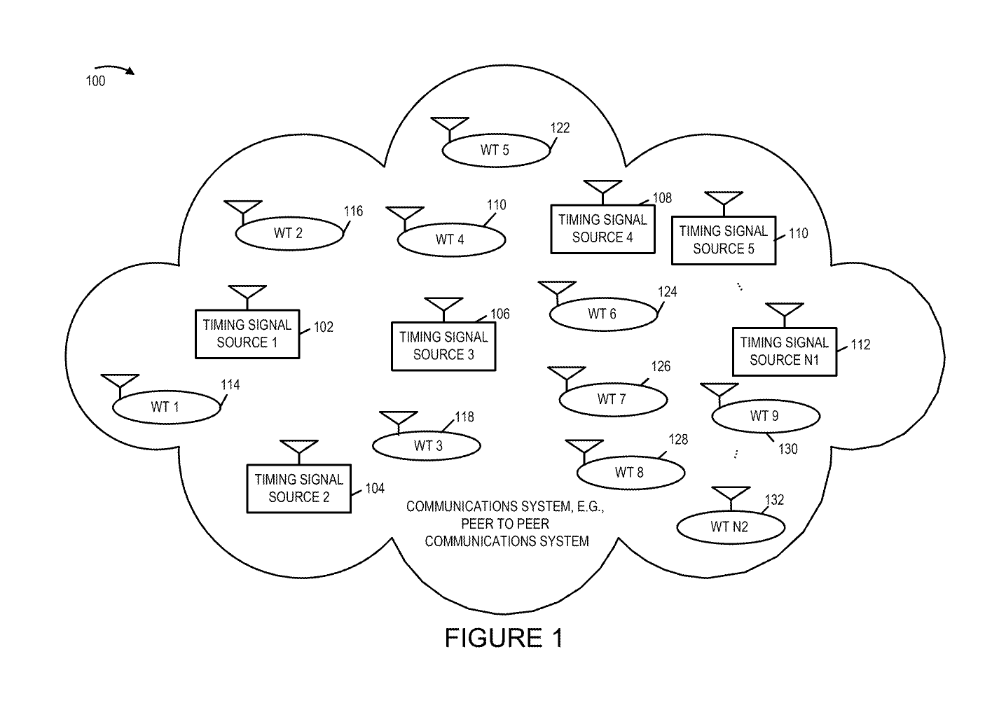

FIG. 1 is a drawing of an exemplary wireless communication system 100, e.g., a peer to peer communications system, in accordance with an exemplary embodiment. Exemplary wireless communications system 100 includes a plurality of timing signal sources (timing signal source 1 102, timing signal source 2 104, timing signal source 3 106, timing signal source 4 108, timing signal source 5 110, . . . , timing signal source N1 112). The timing signals sources include, e.g., base stations, TV station transmitter nodes, radio station transmitter nodes, and reference signal transmitter nodes. Different timing signal sources may, and sometimes do, use different technologies. Different timing signal sources may, and sometimes do, transmit timing signals which are not synchronized with respect to one another. Different timing signal sources may, and sometimes do, transmit timing signals which correspond to different coverage areas.

Exemplary wireless communications system 100 also includes a plurality of wireless terminals (wireless terminal 1 114, wireless terminal 2 116, wireless terminal 3 118, wireless terminal 4 120, wireless terminal 5 122, wireless terminal 6 124, wireless terminal 7 126, wireless terminal 8 128, device 9 130, . . . , wireless terminal N2 132). The wireless terminals are, e.g., mobile wireless nodes. Some of the wireless terminals are handheld mobile devices.

A wireless terminal, e.g., wireless terminal 1 114, monitors for and detects timing signal sources, e.g., local timing signal sources. The wireless terminal selects timing signal sources from the detected timing signal sources, e.g., selects two timing signal sources in accordance with a predetermined timing signal source priority ordering. In some embodiments, the selected timing signal sources are unsynchronized with respect to one another. The wireless terminal determines sets of peer communications time intervals corresponding to the selected timing signals sources. The wireless terminal transmits peer to peer signals, e.g., peer discovery signals, in at least some of the determined peer communications time intervals. The wireless terminal also monitors during at least some of the determined peer communications time intervals.

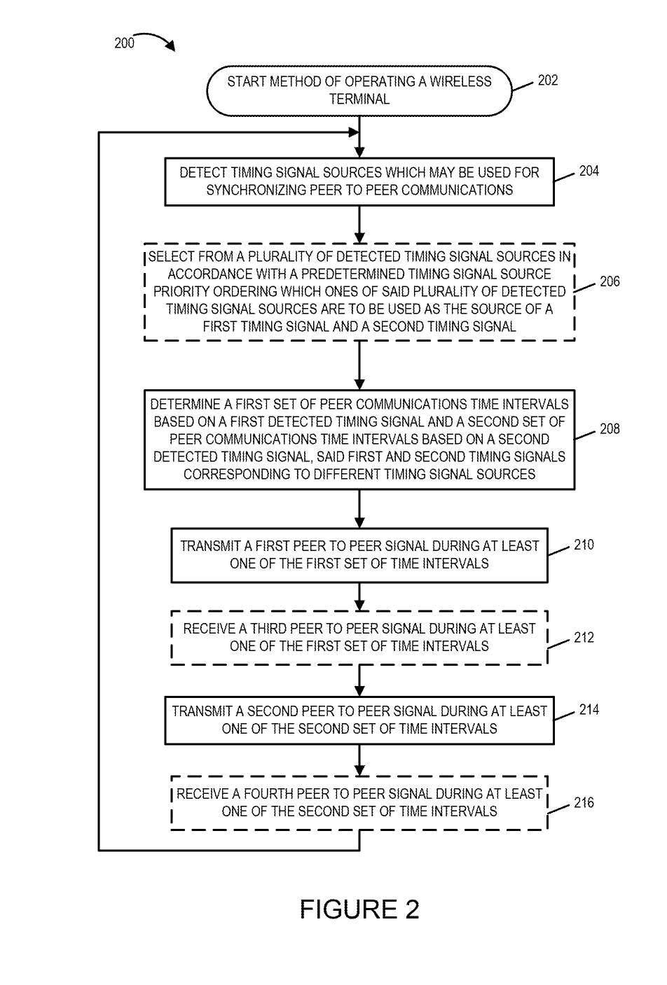

FIG. 2 is a flowchart 200 of an exemplary method of operating a wireless terminal, e.g., mobile node, in accordance with an exemplary embodiment. The exemplary wireless terminal is, e.g., one of the wireless terminals of communications system 100 of FIG. 1. Operation starts in step 202 where the wireless terminal is powered on and initialized and proceeds to step 204.

In step 204 the wireless terminal detects timing signal sources which may be used for synchronizing peer to peer communications. Operation proceeds from step 204 to step 206. In step 206 the wireless terminal selects from a plurality of detected timing signal sources in accordance with a predetermined timing signal source priority ordering which ones of said plurality of detected timing signal sources are to be used as the source of a first timing signal and a second timing signal. In some embodiments the selected timing signal sources correspond to different communications technologies. In some embodiments, the wireless terminal intentionally selects timing signal sources which are not timing synchronized with respect to one another. In some embodiments, the selected timing signal sources may, and sometimes do, correspond to different types. In some embodiments, the first timing signal is from a first timing signal source which is a TV transmitter and the second timing signal is from a second timing signal source which is a cellular base station. In some embodiments, the first timing signal is from a first timing signal source, the second timing signal is from a second timing signal source, and the first and second timing signal sources are different base stations. In some such embodiments the different base stations are not timing synchronized. In various embodiments, at least some of the timing signal sources are not synchronized with respect to one another. In some embodiments, at least some of the timing signal sources transmit timing signals which have different periodicity with respect to one another. In various embodiments some of the timing signal sources correspond to different coverage areas. In some embodiments, timing signal sources with a larger coverage area are treated as having a higher priority than timing signal sources with a smaller coverage area. Operation proceeds from step 206 to step 208.

In step 208 the wireless terminal determines a first set of peer communications time intervals based on a first detected timing signal and a second set of peer communications time intervals based on a second detected timing signal, said first and second timing signals corresponding to different timing signal sources. In some embodiments, the first and second sets of peer communications time intervals are unsynchronized with respect to one another. Operation proceeds from step 208 to step 210.

In step 210 the wireless terminal transmits a first peer to peer signal during at least one of the first set of time intervals. Operation proceeds from step 210 to step 212. In step 212 the wireless communications terminal receives a third peer to peer signal during at least one of the first set of time intervals. Operation proceeds from step 212 to step 214.

In step 214 the first wireless communications terminal transmits a second peer to peer signal during at least one of the second peer to peer timing intervals. Operation proceeds from step 214 to step 216. In step 216 the first wireless communications terminal receives a fourth peer to peer signal during at least one of the second set of time intervals. In some embodiments, the first, second, third and fourth peer to peer signals are control channel signals. In some embodiments, the first, second third and fourth peer to peer signals are peer discovery signals. In some embodiments, a peer discovery signal provides information used to communicate at least one of: a device identifier, a user identifier, a group identifier, a request for information, a request for a service, a request for a product, a response to a request, an advertisement, an offer for a service, an offer of a product and location information. Operation proceeds from step 216 to step 204.

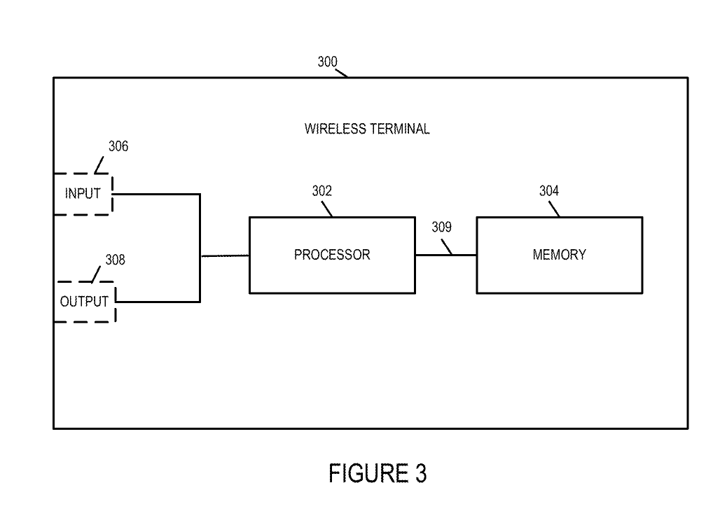

Steps 206, 212 and 216 are optional steps. One, or more or all of step 206, 212 and 216 may be included in an embodiment. The exemplary flow of flowchart 200 has been described for an embodiment in which each of the optional steps 206, 212 and 216 are included. If an optional step is not included, then the step is bypassed in the flow. FIG. 3 is a drawing of an exemplary wireless terminal in accordance with an exemplary embodiment. Exemplary wireless terminal 300 is, e.g., one of the wireless terminals of FIG. 1. Exemplary wireless terminal 300 may, and sometimes does, implement a method in accordance with flowchart 200 of FIG. 2.

Wireless terminal 300 includes a processor 302 and memory 304 coupled together via a bus 309 over which the various elements (302, 304) may interchange data and information. Wireless terminal 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output.

Processor 302 is configured to detect timing signal sources which may be used for synchronizing peer to peer communications. Processor 302 is further configured to determine a first set of peer communications time intervals based on a first detected timing signal and a second set of peer communications time intervals based on a second detected timing signal, said first and second timing signals corresponding to different timing signal sources. Processor 302 is further configured to: transmit a first peer to peer signal during at least one of the first set of time intervals and transmit a second peer to peer signal during at least one of the second set of time intervals. In some embodiments, first and second sets of time intervals are unsynchronized with respect to one another.

In some embodiments, processor 302 is further configured to: select from a plurality of detected timing signal sources in accordance with a predetermined timing signal source priority ordering which ones of said plurality of detected timing signal sources are to be used as the source of said first and second timing signals. In some embodiments, the selected timing signal sources are not synchronized with respect to one another. In some embodiments, said selected timing signal sources correspond to different communications technologies. In some embodiments, timing signal sources with a larger coverage area are treated as having a higher priority than timing signal sources with a smaller coverage area.

In some embodiments, said first timing signal is from a first timing signal source which is a TV transmitter, and the second timing signal is from a second timing signal source which is a cellular base station. In some such embodiments, the TV transmitter is not synchronized with respect to the cellular base station. In some embodiments, said first timing signal is from a first timing signal source, said second timing signal is from a second timing signals source, and the first and second timing signal sources are different base stations which are not timing synchronized.

In various embodiments processor 302 is further configured to receive a third peer to peer signal during at least one of the first set of time intervals and receive a fourth peer to peer signal during at least one of the second set of time intervals. Thus in various embodiments, the wireless terminal may be synchronized with respect to two timing signal sources, e.g., two local timing signal sources which are not synchronized with respect to each other, and may participate in peer to peer communications with other wireless terminals using two different peer to peer timing structures, e.g., two different recurring peer to peer timing structures each including a set of peer communications time intervals.

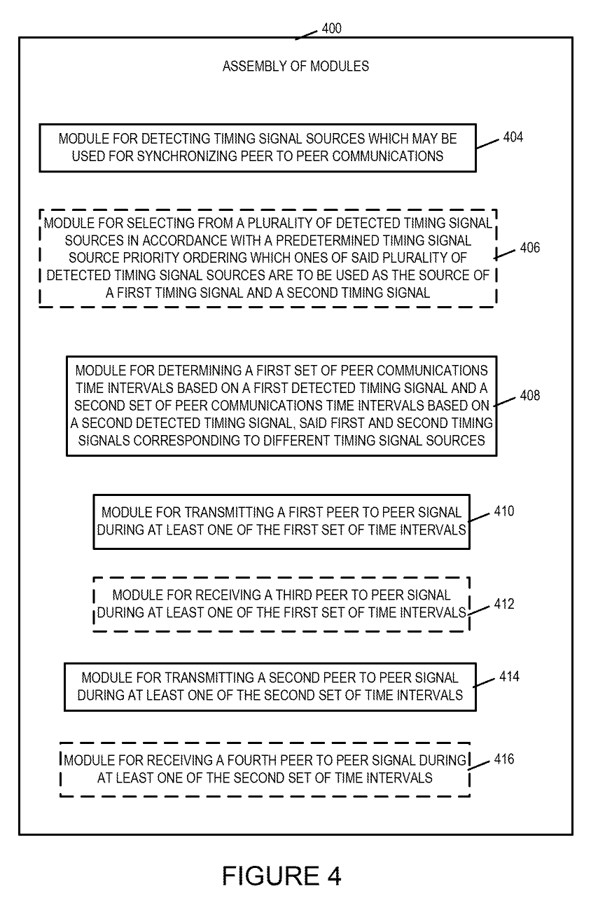

FIG. 4 is an assembly of modules 400 which can, and in some embodiments is, used in the wireless terminal 300 illustrated in FIG. 3. The modules in the assembly 400 can be implemented in hardware within the processor 302 of FIG. 3, e.g., as individual circuits. Alternatively, the modules may be implemented in software and stored in the memory 304 of the wireless terminal device 300 shown in FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the wireless terminal 300 or elements therein such as the processor 302, to perform the functions of the corresponding steps illustrated and/or described in the method of flowchart 200 of FIG. 2.

Assembly of modules 400 includes a module 404 for detecting timing signal sources which may be used for synchronizing peer to peer communications, a module 408 for determining a first set of peer communications time intervals based on a first detected timing signal and a second set of peer communications time intervals based on a second detected timing signal, said first and second timing signals corresponding to different timing signal sources, a module 410 for transmitting a first peer to peer signal during at least one of the first sets of time intervals, and a module 414 for transmitting a second peer to peer signal during at least one of the second set of time intervals. In some embodiments, assembly of modules 400 includes one or more or all of: a module 406 for selecting from a plurality of detected timing signal sources in accordance with a predetermined timing signal source priority ordering which ones of said plurality of detected timing signal sources are to be used as the source of the first and second timing signals, a module 412 for receiving a third peer to peer signal during at least one of the first set of time intervals, and a module 416 for receiving a fourth peer to peer signal during at least one of the second set of time intervals.

In some embodiments, module 406 intentionally selects timing signal sources which are not synchronized with respect to one another from among the plurality of detected timing signal sources. In some embodiments, said selected timing signal sources correspond to different communications technologies. In some embodiments, said first timing signal is from a first timing signal source which is a TV transmitter, and the second timing signal is from a second timing signal source which is a cellular base station. In some embodiments, said first timing signal is from a first timing signal source; said second timing signal is from a second timing signal source; and said first and second timing signal sources are different base stations which are not timing synchronized.

In various embodiments, said first and second sets of time intervals are unsynchronized with respect to one another. In some embodiments, timing signal sources with a larger coverage area are treated as having a higher priority than timing signal sources with a smaller coverage area.

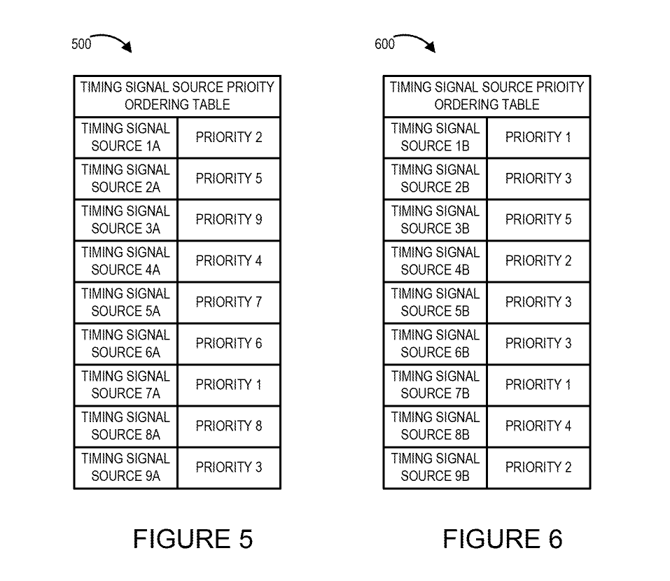

FIG. 5 illustrates an exemplary timing signal source priority ordering table 500 that may be used in the method of flowchart 200 and/or the wireless terminal 300 of FIG. 3 in accordance with an exemplary embodiment. For example, exemplary timing signal source priority ordering table 500 may be used in step 206 of flowchart 200 of FIG. 2 and/or by module 406 of assembly of modules 400 of wireless terminal 300 of FIG. 3.

In table 500 there are nine exemplary timing signal sources (timing signal source 1A, timing signal source 2A, timing signal source 3A, timing signal source 4A, timing signal source 5A, timing signal source 6A, timing signal source 7A, timing signal source 8A, timing signal source 9A), and there is a corresponding priority for each source (priority 2, priority 5, priority 9, priority 4, priority 7, priority 6, priority 1, priority 8, priority 3), respectively. The exemplary timing signal sources (timing signal source 1A, timing signal source 2A, timing signal source 3A, timing signal source 4A, timing signal source 5A, timing signal source 6A, timing signal source 7A, timing signal source 8A, timing signal source 9A), are, e.g., any of the timing signal sources of system 100 of FIG. 1. In one example, a wireless terminal selects the two timing signal sources having the lowest priority numbers from among the plurality of timing signal sources that it has detected. In this example, the lowest priority number corresponds to the highest priority, e.g., priority 1 in the table is the highest priority and priority 9 in the table is the lowest priority.

FIG. 6 illustrates an exemplary timing signal source priority ordering table 600 that may be used in the method of flowchart 200 and/or the wireless terminal 300 of FIG. 3 in accordance with an exemplary embodiment. For example, exemplary timing signal source priority ordering table 600 may be used in step 206 of flowchart 200 of FIG. 2 and/or by module 406 of assembly of modules 400 of wireless terminal 300 of FIG. 3.

In table 600 there are nine exemplary timing signal sources (timing signal source 1B, timing signal source 2B, timing signal source 3B, timing signal source 4B, timing signal source 5B, timing signal source 6B, timing signal source 7B, timing signal source 8B, timing signal source 9B), and there is a corresponding priority for each source (priority 1, priority 3, priority 5, priority 2, priority 3, priority 3, priority 1, priority 4, priority 2), respectively. The exemplary timing signal sources (timing signal source 1B, timing signal source 2B, timing signal source 3B, timing signal source 4B, timing signal source 5B, timing signal source 6B, timing signal source 7B, timing signal source 8B, timing signal source 9B), are, e.g., any of the timing signal sources of system 100 of FIG. 1. In this example, multiple timing signal sources can, and sometimes do, have the same priority level. In some embodiments, a wireless terminal selects the two timing signal sources having the lowest priority numbers from among the plurality of timing signal sources that it has detected. In some such embodiments, if there is a tie condition, detected signal strength measurement information is used to determine which of the alternative timing signal sources with the same priority level to select, e.g., select the one having the higher strength received signal. For example, consider that timing signal sources (2B, 5B, 7B and 8B) have been detected, e.g., received signals from sources 2B, 5B, 7B and 8B signal satisfied minimum received power level detection criteria and/or signal quality criteria to be identified as having been detected. Further consider that the received power level of the signal from timing signal source 5B exceeds the received power level of the signal from timing source 2B. In this example, the wireless terminal selects timing signal source 7B and timing signal source 5B.

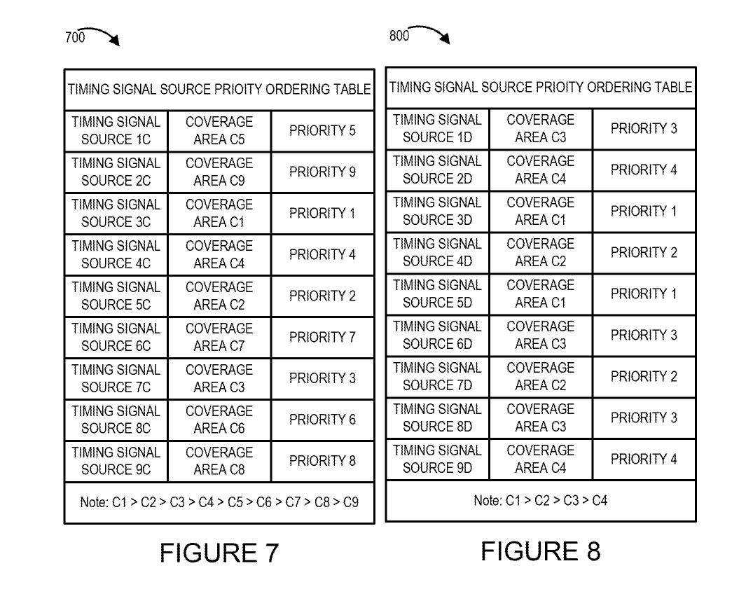

FIG. 7 illustrates an exemplary timing signal source priority ordering table 700 that may be used in the method of flowchart 200 and/or the wireless terminal 300 of FIG. 3 in accordance with an exemplary embodiment. For example, exemplary timing signal source priority ordering table 700 may be used in step 206 of flowchart 200 of FIG. 2 and/or by module 406 of assembly of modules 400 of wireless terminal 300 of FIG. 3.

In table 700 there are nine exemplary timing signal sources (timing signal source 1C, timing signal source 2C, timing signal source 3C, timing signal source 4C, timing signal source 5C, timing signal source 6C, timing signal source 7C, timing signal source 8C, timing signal source 9C), and there is a corresponding coverage area for each source (coverage area C5, coverage area C9, coverage area C1, coverage area C4, coverage area C2, coverage area C7, coverage area C3, coverage area C6, coverage area C8), respectively, and there is a corresponding priority for each source (priority 5, priority 9, priority 1, priority 4, priority 2, priority 7, priority 3, priority 6, priority 8), respectively. In this example, C1>C2>C3>C4>C5>C6>C7>C8>C9. In this example a lower priority number value in the table corresponds to a higher priority level. In this example, a larger coverage area corresponds to a higher priority level. The exemplary timing signal sources (timing signal source 1C, timing signal source 2C, timing signal source 3C, timing signal source 4C, timing signal source 5C, timing signal source 6C, timing signal source 7C, timing signal source 8C, timing signal source 9C), are, e.g., any of the timing signal sources of system 100 of FIG. 1. In one example, a wireless terminal selects the two timing signal sources having the lowest priority numbers from among the plurality of timing signal sources that it has detected. In other words, the wireless terminal selects the two timing signal sources having the largest coverage areas from among the plurality of timing signal sources that it has detected.

FIG. 8 illustrates an exemplary timing signal source priority ordering table 800 that may be used in the method of flowchart 200 and/or the wireless terminal 300 of FIG. 3 in accordance with an exemplary embodiment. For example, exemplary timing signal source priority ordering table 800 may be used in step 206 of flowchart 200 of FIG. 2 and/or by module 406 of assembly of modules 400 of wireless terminal 300 of FIG. 3.

In table 800 there are nine exemplary timing signal sources (timing signal source 1D, timing signal source 2D, timing signal source 3D, timing signal source 4D, timing signal source 5D, timing signal source 6D, timing signal source 7D, timing signal source 8D, timing signal source 9D), and there is a corresponding coverage area for each source (coverage area C3, coverage area C4, coverage area C1, coverage area C2, coverage area C1, coverage area C3, coverage area C2, coverage area C3, coverage area C4), respectively, and there is a corresponding priority for each source (priority 3, priority 4, priority 1, priority 2, priority 1, priority 3, priority 2, priority 3, priority 4), respectively. In this example, C1>C2>C3>C4. In this example, a lower priority number value in the table corresponds to a higher priority level. In this example, a larger coverage area corresponds to a higher priority level. Multiple sources may, and sometimes do, have the same size coverage area and the same priority level. The exemplary timing signal sources (timing signal source 1D, timing signal source 2D, timing signal source 3D, timing signal source 4D, timing signal source 5D, timing signal source 6D, timing signal source 7D, timing signal source 8D, timing signal source 9D), are, e.g., any of the timing signal sources of system 100 of FIG. 1. In one example, a wireless terminal selects the two timing signal sources having the lowest priority numbers from among the plurality of timing signal sources that it has detected. In other words, the wireless terminal selects the two timing signal sources having the largest coverage areas from among the plurality of timing signal sources that it has detected.

In some embodiments, in a case of a tie condition, the wireless terminal uses detected signal strength information to decide which timing signal source to select, e.g., selecting the one with the higher received power. For example, consider that timing signal sources (1D, 3D, 6D and 9D) have been detected, e.g., received signals from sources 1D, 3D, 6D and 9D satisfied minimum received power level detection criteria and/or signal quality criteria to be identified as having been detected. Further consider that the received power level of the signal from timing signal source 6D exceeds the received power level of the signal from timing source 1D. In this example, the wireless terminal selects timing signal source 3D and timing signal source 6D.

In some other embodiments, there is a predetermined secondary priority ordering, e.g., timing source 3D may have priority over timing source 5D in a tie condition; timing source 4D may have priority over timing source 7D in a tie condition; timing source 1D may have priority over timing source 6D and timing source 6D may have priority over timing source 8D in a tie condition. In still other embodiments, in a case of a tie condition the wireless terminal pseudo-randomly selects one of the alternative detected sources which are in a tie condition.

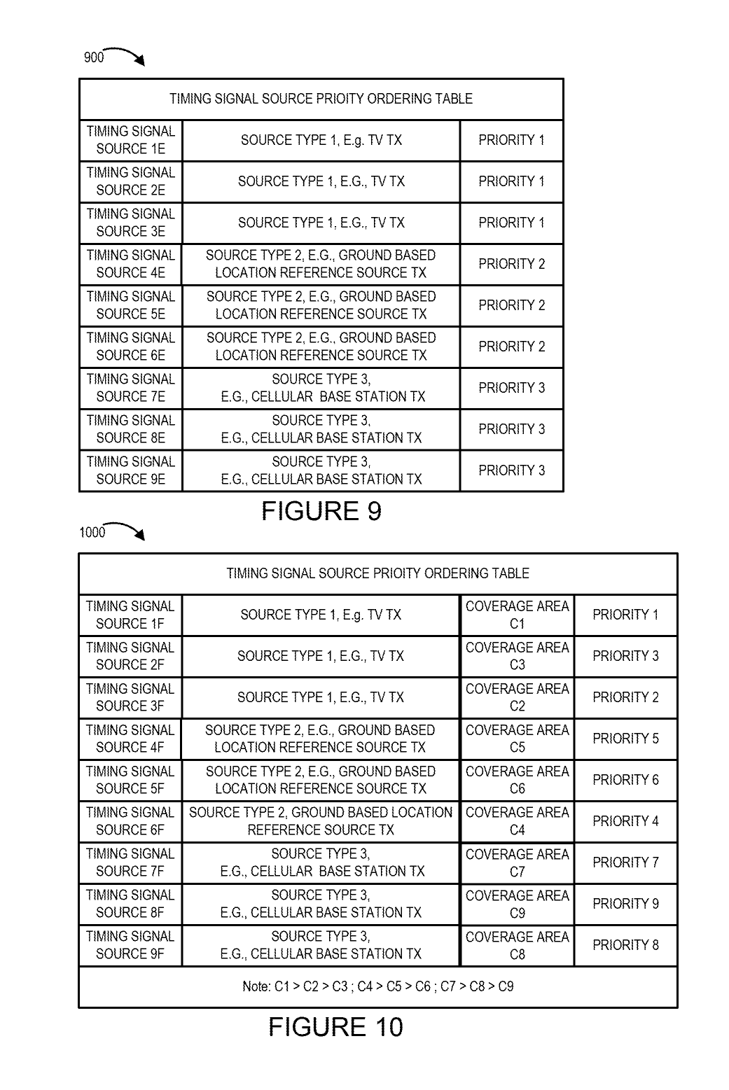

FIG. 9 illustrates an exemplary timing signal source priority ordering table 900 that may be used in the method of flowchart 200 and/or the wireless terminal 300 of FIG. 3 in accordance with an exemplary embodiment. For example, exemplary timing signal source priority ordering table 900 may be used in step 206 of flowchart 200 of FIG. 2 and/or by module 406 of assembly of modules 400 of wireless terminal 300 of FIG. 3.

In table 900 there are nine exemplary timing signal sources (timing signal source 1E, timing signal source 2E, timing signal source 3E, timing signal source 4E, timing signal source 5E, timing signal source 6E, timing signal source 7E, timing signal source 8E, timing signal source 9E), and there is a corresponding source type for each source (source type 1, source type 1, source type 1, source type 2, source type 2, source type 2, source type 3, source type 3, source type 3), respectively, and there is a corresponding priority for each source (priority 1, priority 1, priority 1, priority 2, priority 2, priority 2, priority 3, priority 3, priority 3), respectively. In some embodiments different type sources are not synchronized with respect to one another. For example, in some embodiments, a type 1 source is not synchronized with respect to a type 2 source or a type 3 source; a type 2 source is not synchronized with respect to a type 1 source or a type 3 source; and a type 3 source is not synchronized with respect to a type 1 source or a type 2 source. Source type 1 is, e.g., a TV transmitter; source type 2 is, e.g., a ground based location reference source transmitter; and source type 3 is, e.g., a cellular base station transmitter. The exemplary timing signal sources (timing signal source 1E, timing signal source 2E, timing signal source 3E, timing signal source 4E, timing signal source 5E, timing signal source 6E, timing signal source 7E, timing signal source 8E, timing signal source 9E), are, e.g., any of the timing signal sources of system 100 of FIG. 1. In this example, multiple timing signal sources have the same priority level.

In some embodiments, a wireless terminal selects two timing signal sources. In some such embodiments, when possible, the wireless terminal selects two different types of timing signal sources from among the plurality of timing signal sources that it has detected. For example, the wireless terminal detects timing signal sources and identifies which types of sources from which it has detected at least one timing signal source. Then the wireless terminal identifies the two types of detected sources corresponding to the highest priorities from among detected timing source types, e.g., the two types of sources corresponding to the lowest priority numbers. Then, for each of the two types of sources the wireless terminal selects the source corresponding to the highest received signal power level. For example, consider that the wireless terminal detects timing signal sources 2E, 3E, 7E and 9E, e.g., received signals from sources 2E, 3E, 7E and 9E satisfied minimum received power level detection criteria and/or signal quality criteria to be identified as having been detected. Further consider that the received power level of the timing signal from source 2E exceeds the received power level of the timing signal from source 3E and that the received power level of the timing signal from timing signal source 9E exceeds the received power level of the timing signal from source 7E. In this example, the wireless terminal selects timing signal source 2E and 9E.

FIG. 10 illustrates an exemplary timing signal source priority ordering table 1000 that may be used in the method of flowchart 200 and/or the wireless terminal 300 of FIG. 3 in accordance with an exemplary embodiment. For example, exemplary timing signal source priority ordering table 1000 may be used in step 206 of flowchart 200 of FIG. 2 and/or by module 406 of assembly of modules 400 of wireless terminal 300 of FIG. 3.

In table 1000 there are nine exemplary timing signal sources (timing signal source 1F, timing signal source 2F, timing signal source 3F, timing signal source 4F, timing signal source 5F, timing signal source 6F, timing signal source 7F, timing signal source 8F, timing signal source 9F), and there is a corresponding source type for each source (source type 1, source type 1, source type 1, source type 2, source type 2, source type 2, source type 3, source type 3, source type 3), respectively, and there is a corresponding coverage area for each source (coverage area C1, coverage area C3, coverage area C2, coverage area C5, coverage area C6, coverage area C4, coverage area C7, coverage area C9, coverage area C8), respectively, and there is a corresponding priority for each source (priority 1, priority 3, priority 2, priority 5, priority 6, priority 4, priority 7, priority 9, priority 8), respectively. Source type 1 is, e.g., a TV transmitter; source type 2 is, e.g., a ground based location reference source transmitter; and source type 3 is, e.g., a cellular base station transmitter. Coverage area C1>coverage area C2 and coverage area C2>coverage area C3. Coverage area C4>coverage area C5, and coverage area C5>coverage area C6. Coverage area C7>coverage area C8, and coverage area C8>coverage area C9. The exemplary timing signal sources (timing signal source 1F, timing signal source 2F, timing signal source 3F, timing signal source 4F, timing signal source 5F, timing signal source 6F, timing signal source 7F, timing signal source 8F, timing signal source 9F), are, e.g., any of the timing signal sources of system 100 of FIG. 1. Further consider that each of the 9 timing signal sources in table 1000 are not synchronized with respect to each other. In this example, the priority level associated with a timing signal source is a function of the source type and the coverage area. In this example, a type one source has higher priority than a type 2 source which has higher priority than a type 3 source. Among sources of the same type, coverage area is further used to decide priority with larger coverage area having higher priority.

In some embodiments, a wireless terminal selects the two sources having the highest priority from among the detected sources, e.g., the wireless terminal selects the two sources having the lowest corresponding priority number. For example, consider that the wireless terminal has detected source 3F, source 5F, source 6F, and source 8F e.g., received signals from sources 3F, 5F, 6F and 8F satisfied minimum received power level detection criteria and/or signal quality criteria to be identified as having been detected. The wireless terminal selects source 3F and source 6F from among the group of detected sources, e.g., selecting the two having the highest priority, e.g., the two with the lowest priority number values.

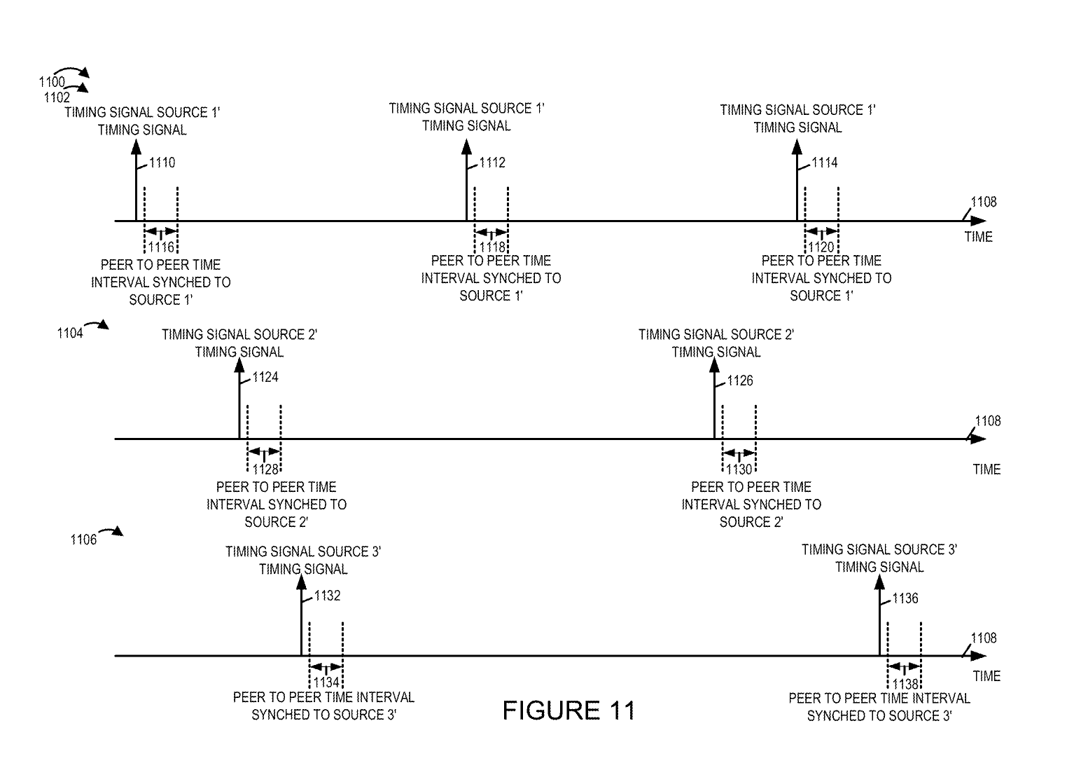

FIG. 11 is a drawing 1100 illustrating exemplary timing signal source signals and corresponding sets of peer to peer time intervals. Drawing 1102 illustrates timing signal source 1′ timing signals (1110, 1112, 1114) and peer to peer time intervals (1116, 1118, 1120) synchronized with respect to timing signal source 1′ which occur along time axis 1108. Drawing 1104 illustrates timing signal source 2′ timing signals (1124, 1126) and peer to peer time intervals (1128, 1130) synchronized with respect to timing signal source 2′ which occur along time axis 1108. Drawing 1106 illustrates timing signal source 3′ timing signals (1132, 1136) and peer to peer time intervals (1134, 1138) synchronized with respect to timing signal source 3′ which occur along time axis 1108. Exemplary timing signal sources (timing signal source 1′, timing signal source 2′, timing signal source 3′) are, e.g., any of the timing signal sources of system 100 of FIG. 1. In this example, the different timing signal sources transmit timing signals with different periodicity. In addition in this example, the different timing signal sources are not synchronized with respect to one another. As shown in FIG. 11 there is one peer to peer time interval corresponding to a timing signal source signal. In various embodiments, there are multiple peer to peer time intervals corresponding to a timing signal source signal. In some embodiments, the number of peer to peer timing intervals in a given time interval is different for at least two timing signal sources in the system. In some embodiments, the duration of a peer to peer timing interval is different for at least two timing signal sources in the system. In some embodiments, the offset of a peer to peer timing interval with respect to a timing signal source timing signal is different for at least two timing signal sources in the system. In various embodiments, a recurring peer to peer timing structure including a plurality of peer to peer time intervals is established which is synchronized with respect to a timing signal source. In some such embodiments, a wireless terminal selects at least two timing signal sources from among the set of detected timing signal sources and establishes at least two recurring peer to peer timing structures. In various embodiments, the selected timing signal sources are not synchronized with respect to one another. In various embodiments, the established recurring peer to peer timing structures are not synchronized with respect to one another.

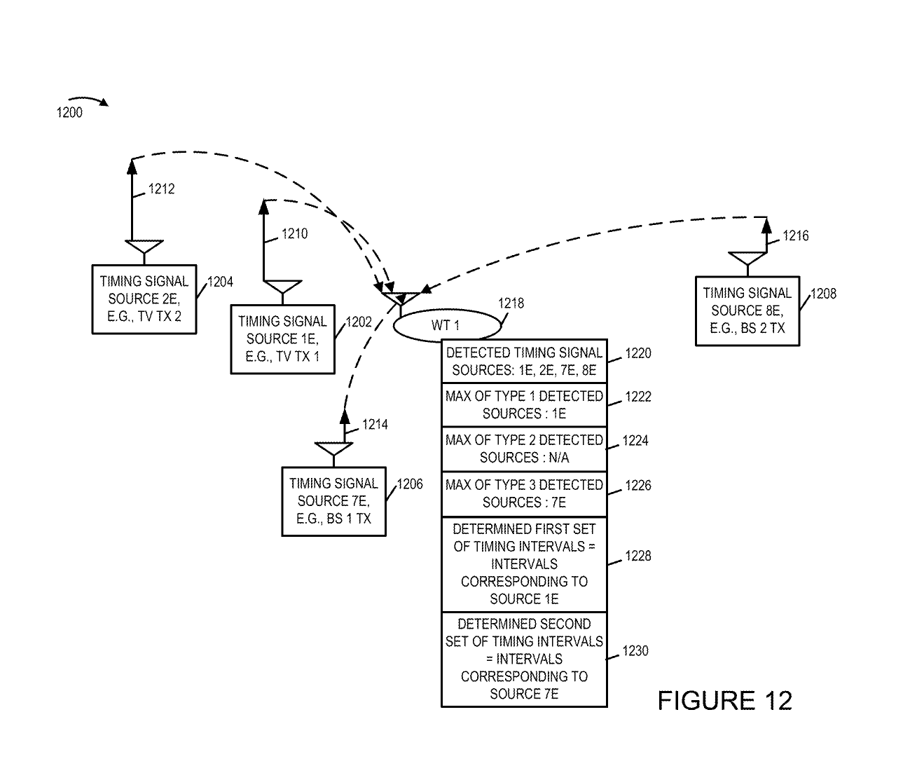

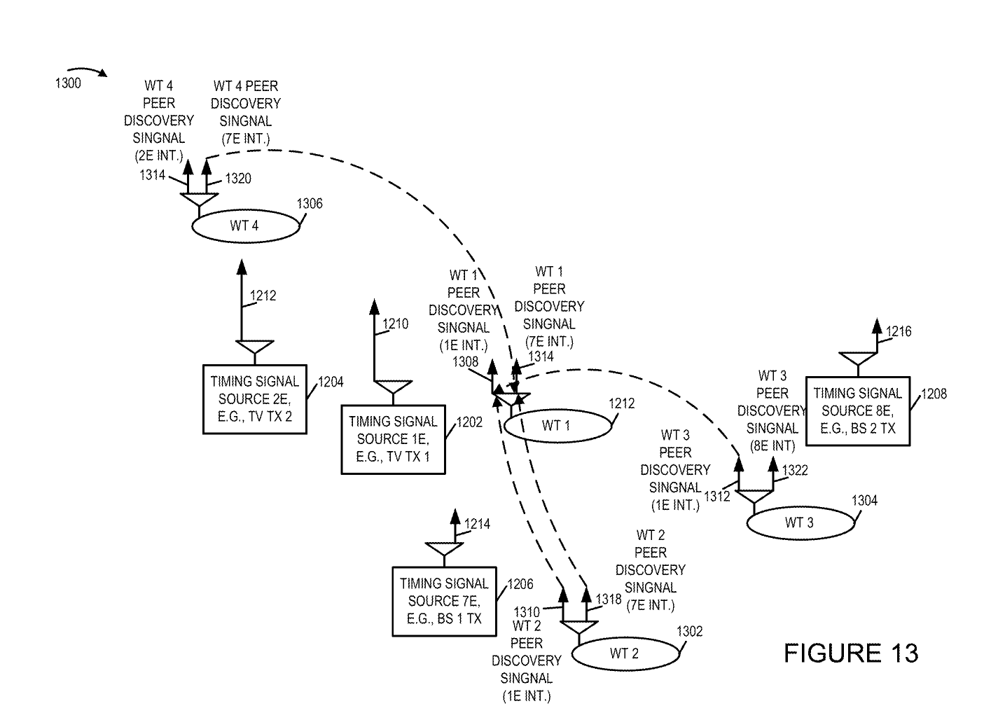

FIGS. 12 and 13 illustrate an example, in which a wireless terminal implements a method in accordance with the method of flowchart 200 using timing signal source priority ordering table 900 of FIG. 9. In Drawing 1200 of FIG. 12, there are four local timing signal sources (timing source 1E 1202, timing source 2E 1204, timing source 7E 1206 and timing source 8E 1208) located in the vicinity of mobile wireless terminal 1 1218. Timing signal source 1E is, e.g., TV transmitter 1; timing signal source 2E is, e.g., TV transmitter 2; timing signals source 7E is, e.g., base station 1 transmitter; and timing signal source 8E is, e.g., base station 2 transmitter.

WT 1 1218 detects timing signals from timing signal sources 1E, 2E, 7E and 8E as indicated by block 1220. WT 1 1218 measures the received signal strength of the detected type 1 source signals and determines that the strongest signal was received from source 1E, as indicated by block 1222. WT 1 1218 determines that no signals from a type 2 sources were detected and thus does not identity a maximum strength type two source as indicated by block 1224. WT 1 1218 measures the received signal strength of the detected type 3 source signals and determines that the strongest signal was received from source 7E, as indicated by block 1226. Wireless terminal 1 1218 determines a first set of timing intervals corresponding to source 1E as indicated by block 1228. Wireless terminal 1 1218 determines a second set of timing intervals corresponding to source 7E as indicated by block 1230.

In drawing 1300 of FIG. 13, in addition to the timing signal sources (1202, 1204, 1206, 1208), other mobile wireless terminals (WT 2 1302, WT 3 1304, WT 4 1306) are shown which are also in the vicinity of WT 1 1212. WT 2 1302 has previously detected for timing signals sources, selected timing signal source 1E and timing signal source 7E and determined corresponding sets of time intervals; e.g., the same sets of time intervals that WT 1 1212 has determined. WT 3 1302 has previously detected for timing signals sources, selected timing signal source 1E and timing signal source 8E and determined corresponding sets of time intervals. Note that WT 3 has one set of determined timing intervals common with WT 1 1212, e.g., the set corresponding to source 1E. WT 4 1306 has previously detected for timing signals sources, selected timing signal source 2E and timing signal source 7E and determined corresponding sets of time intervals. Note that WT 4 has one set of determined timing intervals common with WT 1 1212, e.g., the set corresponding to source 7E.

During a timing interval corresponding to source 1E wireless terminal 1 1212 transmits wireless terminal peer discovery signal 1308, receives wireless terminal 2 peer discovery signal 1310, and receives wireless terminal 3 peer discovery signal 1312. During the timing interval corresponding to source 1E wireless terminal 2 1302 transmits wireless terminal 2 peer discovery signal 1310, receives wireless terminal 1 peer discovery signal 1308, and receives wireless terminal 3 peer discovery signal 1312. During the timing interval corresponding to source 1E wireless terminal 3 1304 transmits wireless terminal 3 peer discovery signal 1312, receives wireless terminal 1 peer discovery signal 1308, and receives wireless terminal 2 peer discovery signal 1310.

During a timing interval corresponding to source 2E, wireless terminal 4 1306 transmits wireless terminal 4 peer discovery signal 1314.

During a timing interval corresponding to source 7E wireless terminal 1 1212 transmits wireless terminal 1 peer discovery signal 1314, receives wireless terminal 2 peer discovery signal 1318, and receives wireless terminal 4 peer discovery signal 1320. During the timing interval corresponding to source 7E wireless terminal 2 1302 transmits wireless terminal 2 peer discovery signal 1318, receives wireless terminal 1 peer discovery signal 1314, and receives wireless terminal 4 peer discovery signal 1320. During the timing interval corresponding to source 7E wireless terminal 4 1306 transmits wireless terminal 4 peer discovery signal 1320, receives wireless terminal 1 peer discovery signal 1314, and receives wireless terminal 2 peer discovery signal 1318.

During a timing interval corresponding to source 8E, wireless terminal 3 1304 transmits wireless terminal 3 peer discovery signal 1322.

In this example, each wireless terminal maintains synchronization with respect to two local timing synchronization sources which it has selected in accordance with a predetermined timing signal source ordering.

Various aspects and/or features of some, but not necessarily all, embodiments will be described. A device, e.g., a mobile wireless terminal, first monitors its environment and detects possible signals which can be used for timing synchronization purposes. The timing synchronization sources are prioritized, e.g., according to a predetermined prioritization scheme. Signals having a longer communications range, in some embodiments, are prioritized over signals with a shorter transmission range for terms of timing synchronization. For example a TV signal may be used as one timing signal source and a cellular network base station as another. The device then selects at least the two highest priority synchronization signals with different timing. The device transmits and/or receives peer to peer signals using at least two different synchronization signals with different timing as the timing synchronization basis for the transmission and/or receipt of different sets of signals. For example the device transmits two different sets of peer discovery signals with the timing of the peer discovery transmissions for the first and second sets of peer discovery signals being based on different local timing synchronization signals. Other peer devices may operate in a similar manner.

Because devices use multiple timing signals and maintain, in essence, multiple timing syncs, the peer device is more likely to be able to detect peers which may have been able to detect one but not necessarily all of the potential local signals which can be used for timing synchronization purposes.

For example, in one embodiment in a network which is only locally synchronized, different devices may synchronize to different timing sources, e.g. different base stations which are not fully synchronized. In this case, a device detecting different timing sources knows that other devices in its vicinity may be using different timing sources as time reference. In this case, the control channels, for example, the peer discovery channels, are going to be sent/monitored on at least two different time intervals which are dependent on which of at least two different timing sources the device is using as the basis for synchronization purposes.

As an example, consider two adjacent WCDMA base stations BS1 and BS2 which are not fully synchronized, and three devices UE1, UE2 and UE3. Assume UE1 is synchronized to BS1, UE2 is synchronized to BS2, and UE3 is at the boundary of the cells and can detect timing signals from both BS1 and BS2. UE1 will send peer discovery channels at time periods T1, which might be periodic and in another embodiment, it can be hopping sequence according to a sequence which is determined by the identity of BS1. Similarly, UE2 will send peer discovery signals at time periods T2, which are different than T1. UE3 can pick one of the base stations, e.g. BS1, as its primary base station and transmit at T1 by synchronizing to BS1 or transmitting according to the hopping sequence of BS1. However, since it is also aware of the second timing clock from BS2, it can also send its peer discovery signals at T2 by synchronizing to BS2, or transmitting according to the hopping sequence of BS2. It can also listen to either or both of the peer discovery signals at times T1 and T2 to get maximum information out of peer discovery. In this way, the peer discovery signals sent by BS1 and BS2 are not always going to collide into each other and each of the devices can retrieve the peer discovery information from both cells.

While described in the context of selecting and using two timing signal sources, in some embodiments more than two timing signal sources are selected and used with each selected timing signal source providing different timing, e.g., the selected timing signal sources are not synchronized. Each of the selected timing signals sources is used in one particular exemplary embodiment for transmitting and/or receiving signals in accordance with the timing determined from the particular selected one of the timing signal sources. In at least some embodiments where multiple different types of timing signal sources are available, N different timing signals sources are selected and used for timing purposes, e.g., discovery signal transmission and reception purposes. In some embodiments N is two. However, in other embodiments N is greater than two, e.g., three, four or five. The N selected timing signal sources in some embodiments differ in the type of signal source in addition to the timing provided. Different types of timing signal sources may include cellular base station signal sources, TV stations, Radio stations and/or other types of local timing signal sources. In some embodiments where there are more than N different types of timing signal sources available, each of the N timing signal sources is selected to be of a different type. When there are more than N different types of timing signal sources available to select from, the selection process may be made according to a predetermined prioritization of timing signal sources according to type. In other embodiments timing signal source coverage area is considered as an alternative to or in addition to timing signal source type when making the selection of which timing signal sources to use at a given time. In at least some such embodiments, timing signal sources with larger coverage areas are preferred over timing signal sources corresponding to small geographic coverage areas.

The techniques of various embodiments may be implemented using software, hardware and/or a combination of software and hardware. Various embodiments are directed to apparatus, e.g., mobile nodes such as mobile terminals, base stations, communications system. Various embodiments are also directed to methods, e.g., method of controlling and/or operating mobile nodes, base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., communications nodes such as access nodes and/or wireless terminals, are configured to perform the steps of the methods described as being performed by the communications nodes. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating a wireless terminal, the method comprising:
detecting timing signal sources which may be used for synchronizing peer to peer communications;
determining a first set of peer communications time intervals based on a first detected timing signal and a second set of peer communications time intervals based on a second detected timing signal, said first and second timing signals corresponding to different timing signal sources;
transmitting a first peer to peer signal during at least one of the first set of time intervals; and
transmitting a second peer to peer signal during at least one of the second set of time intervals.

2. The method of claim 1, further comprising:
selecting from a plurality of detected timing signal sources in accordance with a predetermined timing signal source priority ordering which ones of said plurality of detected timing signal sources are to be used as the source of said first and second timing signals.

3. The method of claim 2, wherein said selected timing signal sources correspond to different communications technologies.

4. The method of claim 2, wherein said first timing signal is from a first timing signal source which is a TV transmitter and wherein the second timing signal is from a second timing signal source which is a cellular base station.

5. The method of claim 2, wherein said first timing signal is from a first timing signal source;
wherein said second timing signal is from a second timing signals source; and
wherein said first and second timing signal sources are different base stations which are not time synchronized.

6. The method of claim 1, wherein said first and second sets of time intervals are unsynchronized with respect to one another.

7. The method of claim 2, wherein timing signal sources with a larger coverage area are treated as having a higher priority than timing signal sources with a smaller coverage area.

8. The method of claim 1, further comprising:
receiving a third peer to peer signal during at least one of the first set of time intervals; and
receiving a fourth peer to peer signal during at least one of the second set of time intervals.

9. A wireless terminal comprising:
means for detecting timing signal sources which may be used for synchronizing peer to peer communications;
means for determining a first set of peer communications time intervals based on a first detected timing signal and a second set of peer communications time intervals based on a second detected timing signal, said first and second timing signals corresponding to different timing signal sources;
means for transmitting a first peer to peer signal during at least one of the first set of time intervals; and
means for transmitting a second peer to peer signal during at least one of the second set of time intervals.

10. The wireless terminal of claim 9, further comprising:
means for selecting from a plurality of detected timing signal sources in accordance with a predetermined timing signal source priority ordering which ones of said plurality of detected timing signal sources are to be used as the source of said first and second timing signals.

11. The wireless terminal of claim 10, wherein said selected timing signal sources correspond to different communications technologies.

12. The wireless terminal of claim 10, wherein said first timing signal is from a first timing signal source which is a TV transmitter and wherein the second timing signal is from a second timing signal source which is a cellular base station.

13. The wireless terminal of claim 10, wherein said first timing signal is from a first timing signal source;
wherein said second timing signal is from a second timing signals source; and
wherein said first and second timing signal sources are different base stations which are not timing synchronized.

14. The wireless terminal of claim 9, wherein said first and second sets of time intervals are unsynchronized with respect to one another.

15. A computer program product for use in a wireless terminal, the computer program product comprising:
a non-transitory computer readable medium comprising:
code for causing at least one computer to detect timing signal sources which may be used for synchronizing peer to peer communications;
code for causing said at least one processor to determine a first set of peer communications time intervals based on a first detected timing signal and a second set of peer communications time intervals based on a second detected timing signal, said first and second timing signals corresponding to different timing signal sources;
code for causing said at least one processor to transmit a first peer to peer signal during at least one of the first set of time intervals; and
code for causing said at least one processor to transmitting a second peer to peer signal during at least one of the second set of time intervals.

16. A wireless terminal comprising:
at least one processor configured to:
detect timing signal sources which may be used for synchronizing peer to peer communications;
determine a first set of peer communications time intervals based on a first detected timing signal and a second set of peer communications time intervals based on a second detected timing signal, said first and second timing signals corresponding to different timing signal sources;
transmit a first peer to peer signal during at least one of the first set of time intervals; and
transmit a second peer to peer signal during at least one of the second set of time intervals; and
memory coupled to said at least one processor.

17. The wireless terminal of claim 16, wherein said at least one processor is further configured to:
select from a plurality of detected timing signal sources in accordance with a predetermined timing signal source priority ordering which ones of said plurality of detected timing signal sources are to be used as the source of said first and second timing signals.

18. The wireless terminal of claim 17, wherein said selected timing signal sources correspond to different communications technologies.

19. The wireless terminal of claim 17, wherein said first timing signal is from a first timing signal source which is a TV transmitter and wherein the second timing signal is from a second timing signal source which is a cellular base station.

20. The wireless terminal of claim 17, wherein said first timing signal is from a first timing signal source;
wherein said second timing signal is from a second timing signals source; and
wherein said first and second timing signal sources are different base stations which are not timing synchronized.
